(19) United States
(12) Patent Application Publication
(10) Pub. No.: US 2005/0030494 A1
(43) Pub. Date: Feb. 10, 2005

(54) Projector apparatus and desk incorporating the same

(75) Inventor: Katsunori Kumai, Hino-shi (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Tokyo (JP)

(21) Appl. No.: 10/910,743

(22) Filed: Aug. 3, 2004

(30) Foreign Application Priority Data
Aug. 7, 2003 (JP) 2003-288946

(51) Int. Cl. G03B 21/22

(52) U.S. Cl. 353/119

(57) ABSTRACT

A projector apparatus to project an image observable by an observer, comprises: a projector projection unit including at least a projection optical system; a projector base unit which is pivotally coupled to the projector projection unit and which is disposed in contact with a mounting surface; and a pivot mechanism configured to pivot the projector projection unit to a storage position and a projecting position. The projector apparatus further comprises a characteristic changing portion configured to vary at least one of electric characteristics and mechanical characteristics of the projector apparatus in accordance with a position of the projector projection unit pivoted by the pivot mechanism.

### CROSS-REFERENCE TO RELATED APPLICATIONS

This application is based upon and claims the benefit of priority from the prior Japanese Patent Application No. 2003-288946, filed Aug. 7, 2003, the entire contents of which are incorporated herein by reference.

### BACKGROUND OF THE INVENTION

1. Field of the Invention

The present invention relates to a projector apparatus to project, to a screen, an image observable by an observer, and to a desk incorporating the same.

2. Description of the Related Art

Projector apparatuses are utilized as means for a plurality of people to simultaneously share video information at, for example, small planning sessions, meetings, large conferences and seminars. That is, the projector apparatus is portable and enables all participants to simultaneously view the same material and understand its content. Thus, the projector apparatus serves in achieving efficient meetings and sessions or convincing presentations.

Since projector apparatuses have not heretofore been light enough to carry with ease, they have only been moved between rooms in the same building and have lacked portability. However, electronic devices have recently been reduced in size and weight along with, for example, development in integrated technology of the electronic devices, so that portable projector apparatuses are also being realized owing to the size reduction.

For example, US 2002/0024637 A1 proposes a projector apparatus in which a digital micromirror device (DMD: a registered trademark of Texas Instruments, Inc., of the United States) is used as a light modulating device.

Herein, the DMD is a device in which a reflective surface is configured by a plurality of square micromirrors arranged in a matrix. Each micromirror has a diagonal pivot shaft, that is a pivot shaft with an inclination of 45 degrees with respect to an arranging direction of the mirror, and is configured to change its direction depending on whether it is turned on or off. In other words, if illumination light and reflected light are arranged to enter/exit along a plane which is perpendicular to the pivot shaft of the micromirror, the reflected light is emitted in a different direction depending on whether the mirror is turned off (off position) or on (on position). Thus, a projection lens is disposed, for example, in a direction in which the reflected light is projected when the mirror is turned on such that the reflected light can be projected on a screen. Therefore, each of the micromirrors of such a DMD is adapted to correspond to a pixel, and each micromirror is turned on/off in accordance with a value of each pixel of an input image, thereby making it possible to configure a projector apparatus which projects an image corresponding to the input image.

The projector apparatus disclosed in US 2002/0024637 A1 described above has the following configuration. Light emitted from a light source in led to an optical system for illumination via an integrator rod. The light emitted from the optical system for illumination has its light path bent by a total internal reflection (TIR) prism, and enters, as the illumination light, the DMD disposed on a DMD substrate. The reflected light (ON light) reflected by the DMD passes through the TIR prism and is projected to the screen by an optical system for projection.

It is to be noted that because the pivot shaft of each mirror of the DMD has an inclination of 45 degrees with respect to the arranging direction of the mirror as described above, the illumination light of the DMD needs to enter from a direction having an inclination of 45 degrees with respect to the arranging direction of the mirror of the DMD. Therefore, in the projector apparatus disclosed in US 2002/0024637 A1 described above, the DMD is mounted on the DMD substrate at an inclination of 45 degrees. The reason that the optical system for illumination which emits the illumination light are not inclined but the DMD is inclined as described above is to enable the projector apparatus to be stored in a small thin case. However, if the DMD is disposed with an inclination of 45 degrees as described above, the image projected to the screen is inclined at 45 degrees. Thus, in US 2002/0024637 A1 described above, a projection unit storing such a configuration is mounted on a projector apparatus base so that it can pivot 45 degrees on a rotation hinge around a shaft vertical to the DMD. In other words, during projection, the projection unit is inclined at 45 degrees so that an erect projection image is projected on the screen.

Furthermore, US 2002/0180939 A1 discloses a projector apparatus having the following configuration of an optical system. That is, a DMD is provided pivotally on a rotational shaft vertical to the DMD. In addition, at least part of an illumination optical system is provided pivotally on the above-mentioned rotational shaft so that direction of irradiation from the illumination optical system to the DMD is not changed. When such a projector apparatus is used, the at least part of the illumination optical system and the DMD are pivoted on the above-mentioned rotational shaft. Thereby, inclination of a picture projected on the screen is corrected.

### BRIEF SUMMARY OF THE INVENTION

According to a first aspect of the present invention, there is provided a projector apparatus to project an image observable by an observer, comprising:
a projector projection unit including at least a projection optical system;
a projector base unit which is pivotally coupled to the projector projection unit and which is disposed in contact with a mounting surface;
a pivot mechanism configured to pivot the projector projection unit to a storage position and a projecting position; and
a characteristic changing portion configured to vary at least one of electric characteristics and mechanical characteristics of the projector apparatus in accordance with a position of the projector projection unit pivoted by the pivot mechanism.

According to a second aspect of the present invention, there is provided a desk comprising:
a projector apparatus to project an image observable by an observer, the projector apparatus including:
   a projector projection unit including at least a projection optical system, the projection optical system including a final lens surface;
   a projector base unit which is pivotally coupled to the projector projection unit and which is disposed in contact with a mounting surface;
   a pivot mechanism configured to pivot the projector projection unit to a storage position and a projecting position; and
   a characteristic changing portion configured to vary at least one of electric characteristics and mechanical characteristics of the projector apparatus in accordance with a position of the projector projection unit pivoted by the pivot mechanism; and
an incorporating portion configured to incorporate the projector apparatus,
a case upper surface of the projector projection unit
   forming the same surface with a top plate of the desk when the projector projection unit is at the storage position, and
   opening up above the top plate of the desk when the projector projection unit is at the projecting position so that the final lens surface of the projection optical system appears on the desk.

According to a third aspect of the present invention, there is provided a projector apparatus to project an image observable by an observer, comprising:
a projector projection unit including projection optical means;
a projector base unit which is pivotally coupled to the projector projection unit and which is disposed in contact with a mounting surface;
pivot means for pivoting the projector projection unit to a storage position and a projecting position; and
characteristic changing means for varying at least one of electric characteristics and mechanical characteristics of the projector apparatus in accordance with a position of the projector projection unit pivoted by the pivot means.

According to a fourth aspect of the present invention, there is provided a desk comprising:
a projector apparatus to project an image observable by an observer, the projector apparatus including:
   a projector projection unit including at least projection optical means, the projection optical means including a final lens surface;
   a projector base unit which is pivotally coupled to the projector projection unit and which is disposed in contact with a mounting surface;
   pivot means for pivoting the projector projection unit to a storage position and a projecting position; and
   characteristic changing means for varying at least one of electric characteristics and mechanical characteristics of the projector apparatus in accordance with a position of the projector projection unit pivoted by the pivot means; and
an incorporating portion for incorporating the projector apparatus,
a case upper surface of the projector projection unit
   forming the same surface with a top plate of the desk when the projector projection unit is at the storage position, and
   opening up above the top plate of the desk when the projector projection unit is at the projecting position so that the final lens surface of the projection optical means appears on the desk.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an outline perspective view showing a configuration of a projector apparatus according to a first embodiment of the present invention;

FIG. 2A is a schematic diagram showing a configuration of a power supply system of the projector apparatus according to the first embodiment when a projector projection unit is at a storage position;

FIG. 2B is a schematic diagram showing the configuration of the power supply system of the projector apparatus according to the first embodiment when the projector projection unit is at a projecting position pivoted 45 degrees from a projector base unit;

FIG. 3A is a diagram showing a planar arrangement relation of internal component members of the projector apparatus according to the first embodiment when the projector projection unit is viewed from above;

FIG. 3B is a diagram showing the planar arrangement relation of the internal component members of the projector apparatus according to the first embodiment when the projector projection unit at the storage position is viewed from a projection image side;

FIG. 3C is a diagram showing the planar arrangement relation of the internal component members of the projector apparatus according to the first embodiment when the projector projection unit at the projecting position pivoted 45 degrees from the projector base unit is viewed from the projection image side;

FIG. 4 is an outline perspective view showing the configuration of the projector apparatus according to a second embodiment of the present invention;

FIG. 5A is an outline perspective view showing the configuration of the projector apparatus according to a third embodiment of the present invention when the projector projection unit is at the projecting position pivoted 45 degrees from the projector base unit;

FIG. 5B is an outline perspective view showing the configuration of the projector apparatus according to the third embodiment when the projector projection unit is at a projecting position pivoted 135 degrees from the projector base unit;

FIG. 6A is a schematic diagram showing the state of a fine adjustment mechanism of the projector apparatus according to a fourth embodiment of the present invention when the projector projection unit is at the storage position;

FIG. 6B is a schematic diagram showing the state of the fine adjustment mechanism of the projector apparatus according to the fourth embodiment when the projector projection unit is at the projecting position pivoted 45 degrees from the projector base unit;

FIG. 7A is an outline perspective view showing a table as one embodiment of a table of the present invention when the projector projection unit is at the storage position;

FIG. 7B is an outline perspective view showing the table when the projector projection unit is at the projecting position;

FIG. 7C is a sectional view showing the vicinity of the projector projection unit of the table; and

FIG. 8 is a sectional view showing the vicinity of the projector projection unit to explain a modification of the table as one embodiment of a desk of the present invention.

### DETAILED DESCRIPTION OF THE INVENTION

[First Embodiment]

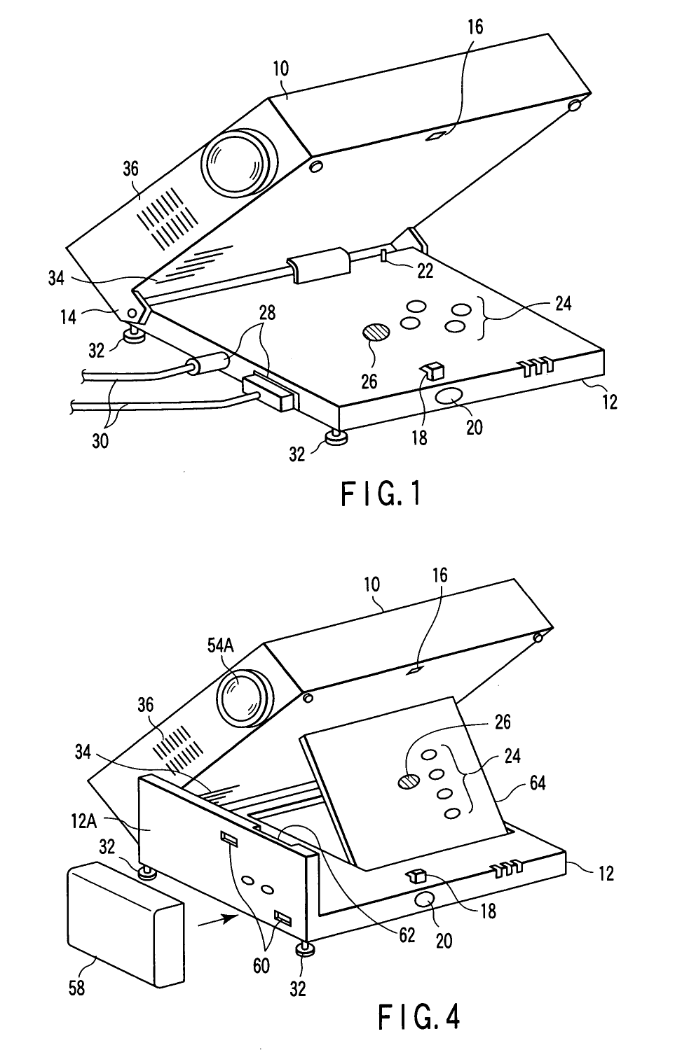

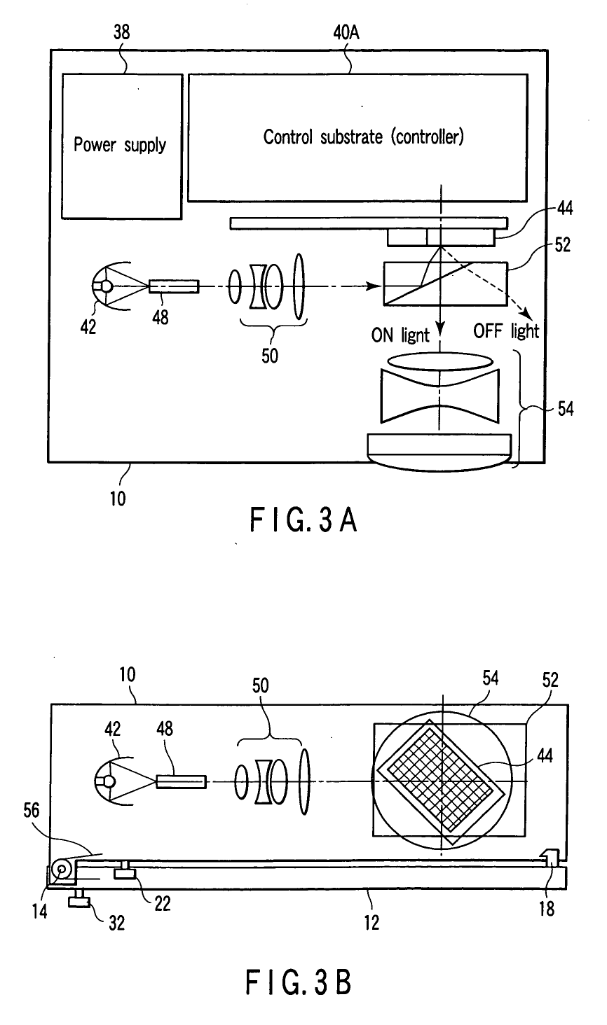

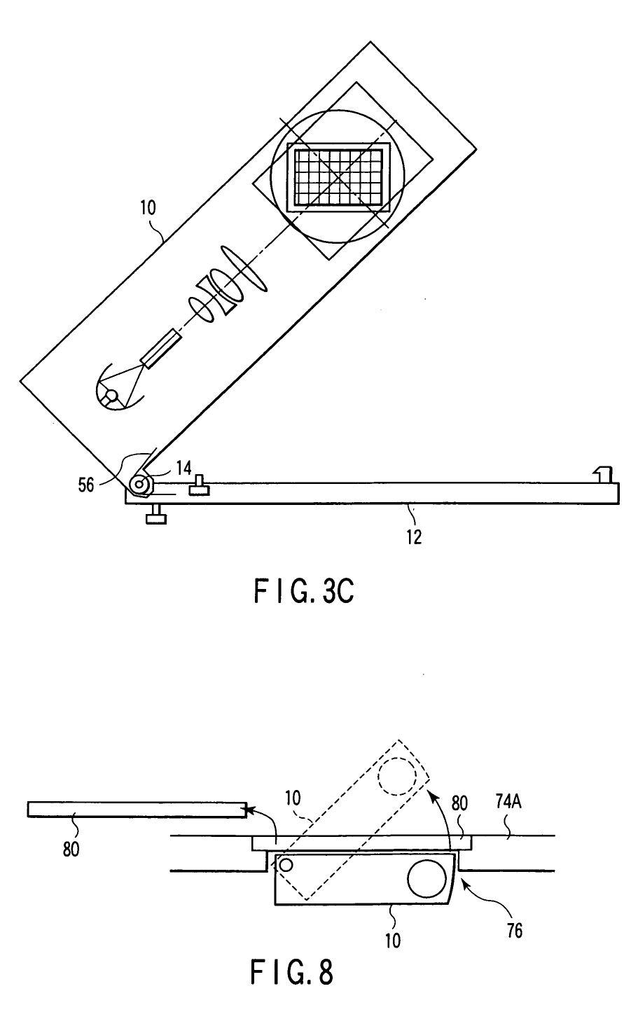

As shown in FIG. 1, a projector apparatus according to a first embodiment of the present invention is configured by a projector projection unit 10 including at least a projection optical system, and a projector base unit 12 disposed in contact with a mounting surface. Here, the projector projection unit 10 is connected to the projector base unit 12 pivotally on a rotation hinge 14. In this case, the projector projection unit 10 is pivoted to a storage position and a projecting position with respect to the projector base unit 12, and is interlocked at each position. That is, an interlocking mechanism at the storage position is configured by a locking hole 16 provided in the projector projection unit 10 and a hook 18 to be engaged therewith provided in the projector base unit 12. This interlocking mechanism prevents the projector projection unit 10 from inadvertently opening with respect to the projector base unit 12, for example, when the projector apparatus is carried. The locking hole 16 and the hook 18 are disengaged by depressing an opening button 20 provided in the projector base unit 12, thus enabling the projector projection unit 10 to open with respect to the projector base unit 12. At this point, in the present embodiment, the projector projection unit 10 is automatically opened by a biasing spring (see FIG. 3B and FIG. 3C) which is provided at a portion of the rotation hinge 14 to apply a biasing force in a direction to open the projector projection unit 10. Naturally, an observer may open the projector projection unit 10 by hand to the projecting position. Then, at the projecting position where the projector projection unit 10 is pivoted 45 degrees from the projector base unit 12, the projector projection unit 10 is fixed by an interlocking mechanism (not shown) at the projecting position. This prevents the projector projection unit 10 from inadvertently closing with respect to the projector base unit 12. That is, the projector projection unit 10 is designed not to close into a state improper for projection during projection and not to injure human bodies. Moreover, the opening of the projector projection unit 10 is detected by a projecting position sensor 22 to enable a power supply to be turned on (details of which will be described later). In other words, the power supply is not turned on in states other than an open state which is suitable for projection.

Furthermore, operation buttons 24 for an operator to control functions of the projector apparatus and a power supply switch 26 to control power supply to the projector apparatus are disposed on a surface opposite to the projector projection unit 10 among surfaces configuring the projector base unit 12. The operation buttons 24 and the power supply switch 26 are operable only when the projector projection unit 10 is fixed at a position pivoted with respect to the projector base unit 12. Therefore, they do not function improperly when the projector apparatus is carried or stored.

It is to be noted that connectors 28 to which cables 30 such as signal lines and power supply line are connected are disposed on a surface vertical to a surface on which the projector is placed among the surfaces configuring the projector base unit 12. That is, if the cables 30 are connected on the side of the projector projection unit 10, a projection image largely sways on a screen surface, for example, when a force is applied to the cables 30 even though the force is small. Thus, the cables 30 are connected to the side of the projector base unit 12 as described above in the present embodiment.

Furthermore, tilt adjustment screws 32 are provided in a lower part of the projector base unit 12 in the vicinity of an end on the side of the projection image. In this case, the two tilt adjustment screws 32 are provided, so that projection inclination can be adjusted in addition to tilt adjustment.

On the other hand, the projector projection unit 10 is provided with an inlet 34 and an outlet 36. In this case, the inlet 34 is disposed on a surface opposite to the projector base unit 12. Thus, the inlet 34 exposes an opening which enables suction, only when the projector projection unit 10 is fixed at the position pivoted with respect to the projector base unit 12. This can prevent entrance of dust from the inlet 34 when the projection is not performed. In addition, it is important to prevent the power supply from being turned on except when the projector projection unit 10 is pivoted to the projecting position as described above because cooling in the projector projection unit 10 can be performed only when the opening of the inlet 34 is exposed.

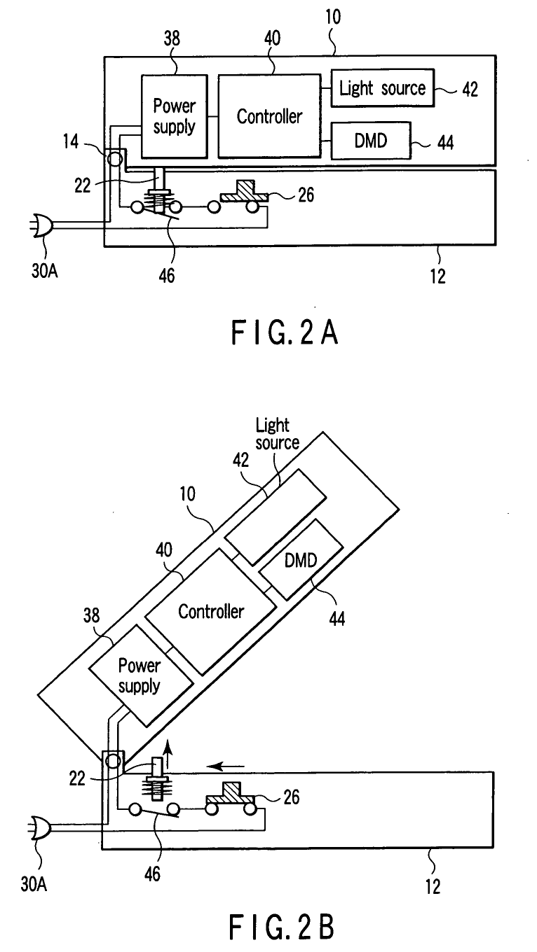

FIG. 2A and FIG. 2B are schematic diagrams showing a configuration of a power supply system of the projector apparatus according to the present embodiment. Here, FIG. 2A shows the projector projection unit 10 at the storage position, and FIG. 2B shows the projector projection unit 10 at the projecting position pivoted 45 degrees with respect to the projector base unit 12.

As shown in FIG. 2A, in the projector projection unit 10, there are arranged a power supply 38, a controller 40 driven by the power supply 38, a light source 42 which is turned on under the control of the controller 40, and a DMD 44 in which each micromirror is turned on/off under the control of the controller 40. A sensor switch 46 and the power supply switch 26 are disposed on a power feed path from a power supply cord 30A connected to the projector base unit 12 to the power supply 38 in the projector projection unit 10.

Here, as shown in FIG. 2A, the sensor switch 46 is pressed down against its own biasing force into an off-state by the projecting position sensor 22 which is pressed down by the projector projection unit 10, when the projector projection unit 10 is at the storage position where it is closed with respect to the projector base unit 12. As shown in FIG. 2B, when the projector projection unit 10 is at the projecting position, the projecting position sensor 22 in moved upward by a spring biasing force, and the sensor switch 46 is brought into an on-state by its own biasing force. In addition, the power supply switch 26 is not operable until this state as described above, and electricity can thus be supplied to the power supply by a sliding operation of the power supply switch 26.

A planar arrangement relation of internal component members of the projector apparatus according to the present embodiment is as shown in FIG. 3A to FIG. 3C. Here, FIG. 3A shows the projector projection unit 10 viewed from above, FIG. 3B shows the projector projection unit 10 at the storage position as viewed from a projection image side, and FIG. 3C shows the projector projection unit 10 at the projecting position pivoted 45 degrees with respect to the projector base unit 12 as viewed from the projection image side. Each member is illustrated with full lines to clarify the arrangement of the internal component members in these diagrams, but it is needless to say that they are not actually visible from the outside.

In the projector projection unit 10, there are arranged the light source 42, an integrator rod 48, an illumination optical system 50, a TIR prism 52, the DMD 44, and a projection optical system 54, as in US 2002/0024637 A1 described above. That is, light emitted from the light source 42 is condensed on the integrator rod 48, led to the TIR prism 52 by the illumination optical system 50, and totally reflected by the TIR prism 52, thereby illuminating the DMD 44. The illumination light thus illuminating is then reflected by the DMD 44 to perform a light modulation, and the light which has passed through the TIR prism 52 after the light modulation is projected by the projection optical system 54. Moreover, as viewed from the projection image side, there are arranged the power supply 38, and a control substrate 40A on which the controller 40 is mounted, in the rear of the light source 42, the integrator rod 48, the illumination optical system 50, the TIR prism 52, and the DMD 44.

Furthermore, as described above, a biasing spring 56 to apply a biasing force in a direction to open the projector projection unit 10 is provided at the portion of the rotation hinge 14. This biasing spring 56 automatically opens the projector projection unit 10 from a state shown in FIG. 3B to a state shown in FIG. 3C when the engagement by the hook 18 is cancelled.

[Second Embodiment]

In the projector apparatus according to a second embodiment of the present invention, a battery 58 is used instead of the power supply cord 30A in the first embodiment, as shown in FIG. 4. Therefore, a base wall surface 12A on the projection image side of the projector base unit 12 is erected, where a battery locking portion 60 to lock the battery 58 is provided. Thus, by attaching the heavy battery 58 to the side of the projector base unit 12, the center of gravity is lowered and stability is increased. Connectors (not shown) for other cables among the cables 30 are provided on a side surface opposite to the base wall surface 12A so that the other cables can be attached to the side surface opposite to the base wall surface 12A.

Furthermore, the base wall surface 12A of the projector base unit 12 is provided with a depression 62 in accordance with a rise of a final lens surface 54A which protrudes from the projector projection unit 10 among the projection optical system 54. This depression 62 prevents the final lens 54A from contacting the base wall surface 12A when the projector projection unit 10 is about to be closed. Thus, the final lens surface 54A appears at an observable position only when the projector projection unit 10 is at the projecting position. In this way, the base wall surface 12A serves as a lens cover when the projector projection unit 10 is at the storage position, thereby enabling the final lens surface 54A to be protected and to be prevented from being flawed and covered with dust.

Still further, an outlet 36 used to release heat in the projector projection unit 10 is disposed on the surface opposite to the base wall surface 12A of the projector base unit 12 to which the battery 58 is attached among surfaces configuring the projector projection unit 10. This outlet 36 exposes an opening which enables air discharge, only when the projector projection unit 10 is fixed at the projecting position pivoted with respect to the projector base unit 12. This can prevent entrance of dust and foreign objects from the outlet 36 when the projection is not performed. Naturally, the inlet 34 has the same configuration as that in the first embodiment, and it is needless to say that the entrance of dust and foreign objects from the inlet 34 can be prevented when the projection is not performed.

Further yet, in the present embodiment, the projector base unit 12 is configured in such a manner that an operation panel 64 provided with operation switches such the power supply switch 26 and the operation buttons 24 pivots. The operation panel 64 is adapted to pivot to allow easier operation and allow the opened projector projection unit 10 to be supported by the pivoted operation panel 64. Naturally, such a configuration of the operation panel 64 is also applicable in the first embodiment.

[Third Embodiment]

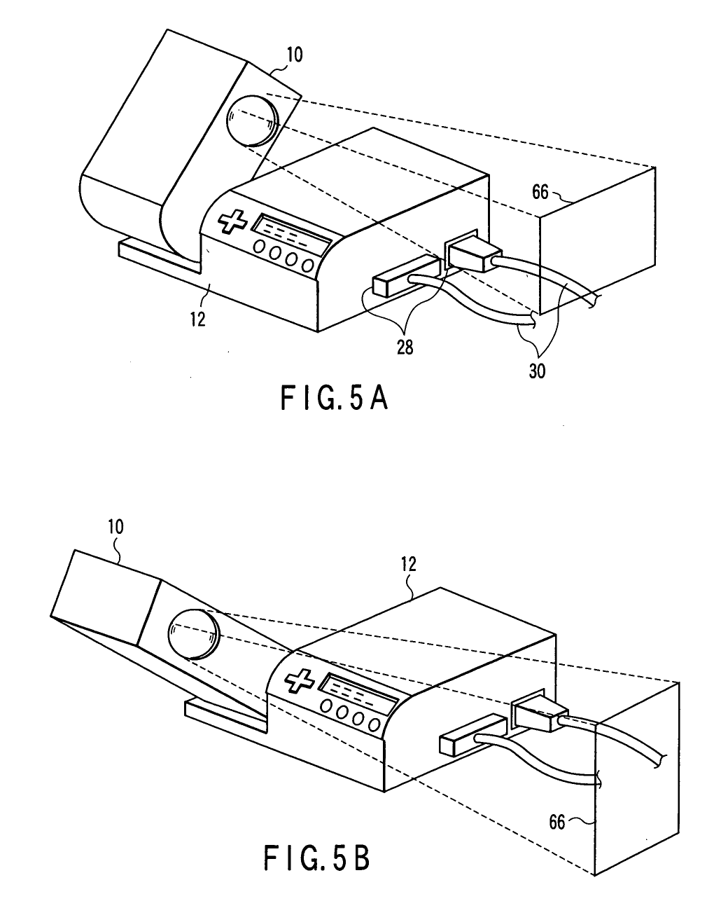

In the projector apparatus according to a third embodiment of the present invention, the component members which do not need to be rotated, such as the power supply 38 and the light source 42, are stored in the projector base unit 12. Thus, the projector base unit 12 is thick and box-shaped as shown in FIG. 5A and FIG. 5B. Moreover, in the projector apparatus according to the present embodiment, various operation members such as the operation buttons and the power supply switch are always exposed regardless of whether the projector projection unit 10 is pivoted, unlike those in the first and second embodiments described above. Therefore, even if the operation members are operated, the projector apparatus according to the present embodiment is preferably configured so that it is not actuated in accordance with the operation of the operation members until the projector projection unit 10 is detected that it is pivoted to the projecting position.

Furthermore, in the configuration of the present embodiment, two positions can be selected as the projecting positions to which the projector projection unit 10 is pivoted: a position pivoted 45 degrees with respect to the projector base unit 12 as shown in FIG. 5A, and a position pivoted 135 degrees with respect to the projector base unit 12 as shown in FIG. 5B. That is, the projector projection unit 10 is interlocked at the respective projecting positions by respective locking mechanisms (not shown). At the projecting position at 45 degrees as shown in FIG. 5A, a projection image 66 which is horizontally long in an aspect ratio can be obtained. Therefore, at such a projecting position, the same display function can be performed as that performed by an ordinary display. In addition, at the projecting position at 135 degrees as shown in FIG. 5B, the projection image 66 which is vertically long in the aspect ratio can be obtained. Therefore, at such a projecting position, it is possible to perform display which is suitable for horizontally written documents such as a word processing screen. As a selection can be made from the two projecting positions, optimum display can be performed in accordance with an image to be displayed. It is to be noted that, preferably, for example, all the micromirrors of the DMD are turned off so that an image is not projected when the projector projection unit 10 is pivoted between 45 degrees and 135 degrees. This can prevent an inclined image to be displayed.

Still further, in the present embodiment, the power supply 38, the light source 42 and the like are stored on the side of the projector base unit 12 as described above. Thereby, the gravity point of the projector projection unit 10 is shifted to the side of its pivoting shaft so that the gravity point of the entire projector apparatus is located in an upper part the projector base unit 12. Therefore, even if the projector projection unit 10 is pivoted 135 degrees as shown in FIG. 5B, stability is not reduced.

It is to be noted that as in the second embodiment described above, the openings of the inlet and the outlet are exposed and the final lens surface 54A of the projection optical system 54 appears when the projector projection unit 10 is at the projecting position, but these are not shown in the drawings.

[Fourth Embodiment]

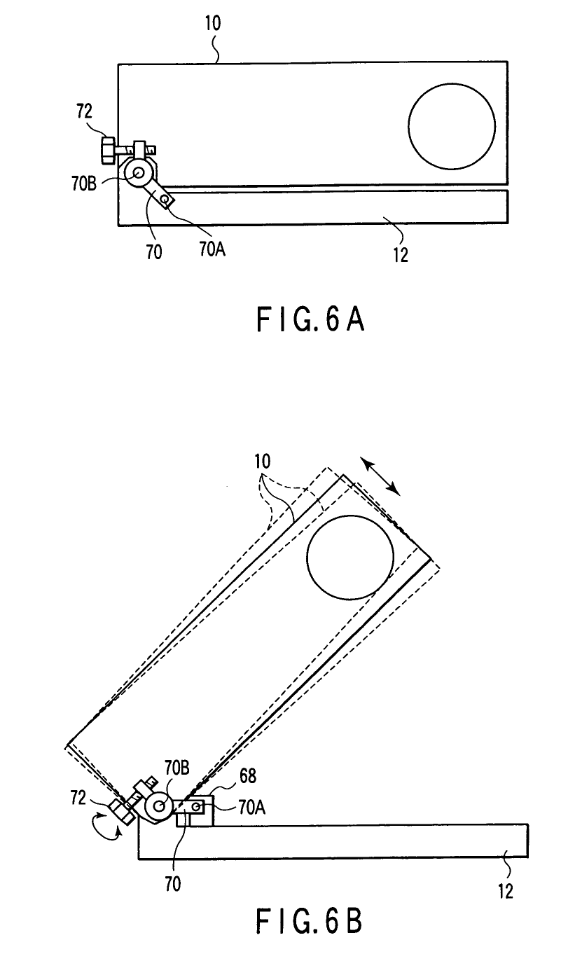

In the configuration of the projector apparatus according to a fourth embodiment of the present invention, a locking member 68 is engaged with a locking hole 70A of a locking member 70 so that the projector projection unit 10 is fixed in a closed state as shown in FIG. 6A and FIG. 6B. Further, on a rotational shaft 70B of the locking member 70, a rotational position relation between the projector projection unit 10 and the projector base unit 12 is determined by an adjustment screw 72.

That is, after the projector projection unit 10 is once fixed in an open state at the projecting position, the adjustment screw 72 can be turned to make a fine adjustment in a relative angle relation between the projector projection unit 10 and the projector base unit 12. Thereby, inclination of the surface on which the projector is placed is corrected so that the long side (or short side) of the projection image can be adapted to a vertical direction.

[Embodiment of Desk]

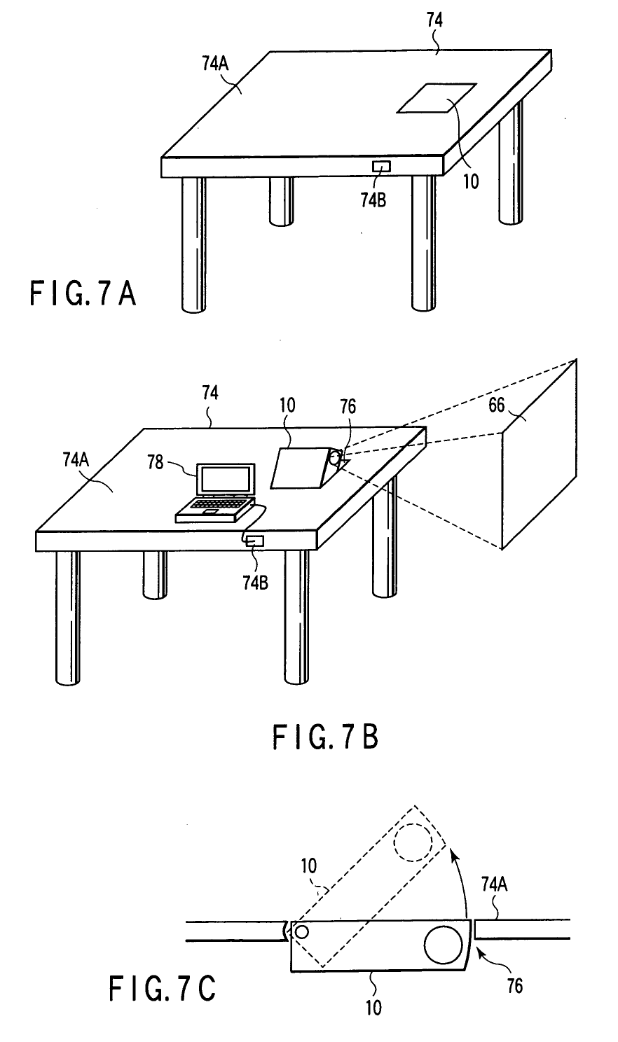

Next, a table 74 as one embodiment of a desk incorporating any of the projector apparatuses according to first to fourth embodiments will be described referring to FIG. 7A to FIG. 7C. More specifically, this table 74 incorporates any of the projector apparatuses according to first to fourth embodiments into an incorporating portion 76. When an image is projected, as shown in FIG. 7B and as indicated by broken lines in FIG. 7C, the projector projection unit 10 pops up at the projecting position. Moreover, when projection is not performed, as shown in FIG. 7A and as indicated by full lines in FIG. 7C, the projector projection unit 10 is at the storage position. At this storage position, an upper surface of the projector projection unit 10 forms the same surface with a table top plate 74A without becoming an obstacle.

It is to be noted that the projector projection unit 10 may be, at the storage position, unlocked by being once pressed down toward a floor, or a button corresponding to the opening button 20 may be provided on a side surface of the table 74. Alternatively, such a configuration may also be possible that a screw or a handle is provided on the side surface of the table 74 and turned to pivot the projector projection unit 10.

Furthermore, a screen surface to display the projection image 66, the table 74 (projector apparatus), and a position around the table 74 where the observer is seated to observe the projection image 66 are prescribed. Thus, the projecting direction (tilting angle) and inclination of the projector projection unit 10 at the projecting position are constant. Therefore, no specific mechanism for fine adjustment of the projecting direction and inclination is needed. Nevertheless, such a fine adjustment mechanism may naturally be provided.

In addition, it is needless to say that the table 74 comprises a connection portion 74B to receive image data to be projectively displayed which is generated by image generating means of a PC 78 or the like.

Furthermore, as shown in FIG. 8, a detachable cover 80 may be configured to form the same surface with the table top plate 74A. In such a case, the cover 80 endures the weight of what is placed on the table top plate 74A and the projector projection unit 10 is not directly subjected to the weight, so that there is less fear of troubles. Additionally, even if the cover 80 is broken by the weight, only the cover 80 may be replaced.

While the present invention has been described above in connection with the embodiments, the present invention is not limited to the embodiments described above, and various modifications and applications can naturally be made within the spirit of the present invention. For example, the projector apparatus may be embedded not only in the table, but also in a ceiling surface, wall surface or floor surface. In the case of the wall surface, the projector projection unit 10 opens by its own weight if the pivoting shaft is on a lower side, thus requiring no specific biasing member.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. A projector apparatus to project an image observable by an observer, comprising:
a projector projection unit including at least a projection optical system;
a projector base unit which is pivotally coupled to the projector projection unit and which is disposed in contact with a mounting surface;
a pivot mechanism configured to pivot the projector projection unit to a storage position and a projecting position; and
a characteristic changing portion configured to vary at least one of electric characteristics and mechanical characteristics of the projector apparatus in accordance with a position of the projector projection unit pivoted by the pivot mechanism.

2. The projector apparatus according to claim 1, further comprising:
a power supply section configured to be capable of supplying electricity into the projector apparatus, wherein
the characteristic changing portion varies the electric characteristics of the projector apparatus by controlling the power supply section so as to be capable of supplying electricity into the projector apparatus only when the projector projection unit is at the projecting position.

3. The projector apparatus according to claim 2, wherein the power supply section includes a battery.

4. The projector apparatus according to claim 1, further comprising:
an operation member configured to enable the observer to manipulate operation of the projector apparatus, wherein
the characteristic changing portion varies the electric characteristics of the projector apparatus by controlling so as to be capable of operation of the projector apparatus by the operation member only when the projector projection unit is at the projecting position.

5. The projector apparatus according to claim 4, further comprising:
a power supply section configured to be capable of supplying electricity into the projector apparatus, wherein
the characteristic changing portion varies the electric characteristics of the projector apparatus by controlling the power supply section so that electricity is supplied into the projector apparatus, only when the projector projection unit is at the projecting position and the operation member instructs to supply electricity into the projector apparatus.

6. The projector apparatus according to claim 5, wherein the operation member includes a power supply switch.

7. The projector apparatus according to claim 5, wherein the power supply section includes a battery.

8. The projector apparatus according to claim 1, further comprising:
an inlet configured to enable air to flow into the projector apparatus from the outside, wherein
the characteristic changing portion varies the mechanical characteristics of the projector apparatus by closing the inlet only when the projector projection unit is at the storage position.

9. The projector apparatus according to claim 1, further comprising:
an outlet configured to enable air to be discharged from the projector apparatus to the outside, wherein
the characteristic changing portion varies the mechanical characteristics of the projector apparatus by closing the outlet only when the projector projection unit is at the storage position.

10. The projector apparatus according to claim 1, wherein the projection optical system includes a final lens surface configured to appear at a position observable by the observer only when the projector projection unit is at the projecting position.

11. The projector apparatus according to claim 1, wherein the projector base unit comprises a connector configured to connect at least one of a telecommunication cable and a power supply cable.

12. The projector apparatus according to claim 1, wherein the pivot mechanism includes a biasing member configured to apply a biasing force in a direction to open the projector projection unit with respect to the projector base unit.

13. The projector apparatus according to claim 12, wherein the pivot mechanism further includes an interlocking member configured to interlock the projector projection unit which is at the projecting position with respect to the projector base unit.

14. The projector apparatus according to claim 12, wherein the pivot mechanism further includes an interlocking member configured to interlock the projector projection unit which is at the storage position with respect to the projector base unit.

15. The projector apparatus according to claim 1, wherein the projector base unit comprises at least one tilt adjustment mechanism configured to adjust a gap between the mounting surface and the projector base unit, on a surface contacting the mounting surface and on a line substantially perpendicular to a pivoting shaft on which the pivot mechanism pivots the projector projection unit.

16. The projector apparatus according to claim 1, wherein an angle at which the pivot mechanism pivots the projector projection unit from the storage position to the projecting position is 45 degrees.

17. The projector apparatus according to claim 16, wherein an image projected by the projection optical system when the projector projection unit is at the projecting position is horizontally long in an aspect ratio.

18. The projector apparatus according to claim 1, wherein an angle at which the pivot mechanism pivots the projector projection unit from the storage position to the projecting position is 135 degrees.

19. The projector apparatus according to claim 18, wherein an image projected by the projection optical system when the projector projection unit is at the projecting position is vertically long in the aspect ratio.

20. The projector apparatus according to claim 18, wherein the projector projection unit is configured to shift its gravity point to a side of the pivoting shaft so that a gravity point of the entire projector apparatus is located in an upper part of the projector base unit when the projector projection unit is at the projecting position.

21. The projector apparatus according to claim 18, wherein the pivot mechanism includes an adjustment mechanism configured to enable the observer to make a fine adjustment of the angle at which the projector projection unit is pivoted.

22. The projector apparatus according to claim 1, wherein 45 degrees and 135 degrees can be selected as the angle at which the pivot mechanism pivots the projector projection unit from the storage position to the projecting position.

23. The projector apparatus according to claim 22, wherein the projector projection unit is configured not to project an image when the pivot mechanism pivots the projector projection unit from 45 degrees to 135 degrees.

24. The projector apparatus according to claim 22, wherein the pivot mechanism includes an adjustment mechanism configured to enable the observer to make a fine adjustment of the angle at which the projector projection unit is pivoted.

25. A desk comprising:
a projector apparatus to project an image observable by an observer, the projector apparatus including:
a projector projection unit including at least a projection optical system, the projection optical system including a final lens surface;
a projector base unit which is pivotally coupled to the projector projection unit and which is disposed in contact with a mounting surface;
a pivot mechanism configured to pivot the projector projection unit to a storage position and a projecting position; and
a characteristic changing portion configured to vary at least one of electric characteristics and mechanical characteristics of the projector apparatus in accordance with a position of the projector projection unit pivoted by the pivot mechanism; and
an incorporating portion configured to incorporate the projector apparatus,
a case upper surface of the projector projection unit
forming the same surface with a top plate of the desk when the projector projection unit is at the storage position, and
opening up above the top plate of the desk when the projector projection unit is at the projecting position so that the final lens surface of the projection optical system appears on the desk.

26. The desk according to claim 25, wherein the case upper surface of the projector projection unit is made of the same material as the top plate of the desk.

27. The desk according to claim 26, wherein the case upper surface of the projector projection unit is configured detachably from the projector projection unit.

28. A projector apparatus to project an image observable by an observer, comprising:
a projector projection unit including projection optical means;
a projector base unit which is pivotally coupled to the projector projection unit and which is disposed in contact with a mounting surface;
pivot means for pivoting the projector projection unit to a storage position and a projecting position; and
characteristic changing means for varying at least one of electric characteristics and mechanical characteristics of the projector apparatus in accordance with a position of the projector projection unit pivoted by the pivot means.

29. A desk comprising:
a projector apparatus to project an image observable by an observer, the projector apparatus including:
a projector projection unit including at least projection optical means, the projection optical means including a final lens surface;
a projector base unit which is pivotally coupled to the projector projection unit and which is disposed in contact with a mounting surface;
pivot means for pivoting the projector projection unit to a storage position and a projecting position; and
characteristic changing means for varying at least one of electric characteristics and mechanical characteristics of the projector apparatus in accordance with a position of the projector projection unit pivoted by the pivot means; and
an incorporating portion for incorporating the projector apparatus,
a case upper surface of the projector projection unit
forming the same surface with a top plate of the desk when the projector projection unit is at the storage position, and
opening up above the top plate of the desk when the projector projection unit is at the projecting position so that the final lens surface of the projection optical means appears on the desk.
